(19) United States
(12) Patent Application Publication
(10) Pub. No.: US 2010/0027769 A1
(43) Pub. Date: Feb. 4, 2010

(54) GLOBAL TELECOMMUNICATIONS NETWORK PROACTIVE REPOSITORY, WITH COMMUNICATION NETWORK OVERLOAD MANAGEMENT

(76) Inventors: Jeffrey Stevens, Cupertino, CA (US); Mark E. Laubach, Cupertino, CA (US); Curtis Stevens, Santa Clara, CA (US); Anthony J. Rockmore, Menlo Park, CA (US); Brian McCune, Menlo Park, CA (US)

Correspondence Address: Jeffrey Stevens, 20282 Pacifica Drive, Cupertino, CA, 95014, US

(21) Appl. No.: 11/833,177

(22) Filed: Aug. 2, 2007

Related U.S. Application Data
(60) Provisional application No. 60/821,386, filed on Aug. 3, 2006.
(60) Provisional application No. 60/941,484, filed on Jun. 1, 2007.

(51) Int. Cl. H04M 1/64; G06F 21/00; H04M 11/00

(52) U.S. Cl. 379/88.17; 726/26; 379/93.01

(57) ABSTRACT

A proactive repository stores authenticated information regarding Entities and their properties. A set of conditions and policies is associated with the information in the repository. These conditions govern the release of information to an authorized recipient. Release conditions include various forms of activation, such as activation of emergency services dispatch, a change in condition of a public utility, a change in geophysical or meteorological conditions, etc. At least one responsible third party can authenticate Entities, agents agencies and the like, validate associated credentials, and store received information in the repository. A first proactive repository can be stored within a second proactive repository. A proactive repository can provide the facilities of a multi-modal notification delivery system.

### RELATED APPLICATIONS

This application claims the benefit of U.S. Provisional Application Ser. No. 60/821,386, entitled “Global Telecommunications Network Proactive Repository” and filed on Aug. 3, 2006, and of U.S. Provisional Application Ser. No. 60/941,484, entitled “Global Telecommunications Network Proactive Repository, with Communication Network Overload Management” and filed on Jun. 1, 2007. The entirety of both above-referenced United States Provisional Applications is incorporated herein by reference.

### BACKGROUND

Since the Sep. 11, 2001 terrorist attack on the United States, with the destruction of the World Trade center towers in New York City, the United States, in particular, as well as other nations of the world, have significantly increased the importance of homeland security. In the United States, for example, efforts to date have focused in several areas, such as information sharing and analysis for recognition of terrorist preparation; development of community, state, and federal disaster planning for preparedness and response; and prevention and protection related to threats to national infrastructure.

A major impact of the increased focus on homeland security is the development of national and state planning, and the availability of funding for local communities (cities, towns, villages, etc.) for various programs. To date, such programs have been used to strengthen public information outreach, increase training, and improve assets and resources, e.g. equipment. Mass emergency notification systems have also appeared that use the telephone network as a primary means for contacting the community. Citizens within a community are either pre-registered or they may optionally register their phone number. Mass notification systems themselves are in their infancy for several reasons. Specifically, they tend to be an electronic replacement for the legacy civil defense community warning sirens in that everyone is notified equally, and secondarily they tend to be ignorant of the conditions of the delivery mechanisms. It is known in the art of mass notification that in some system implementations recipients can specify an initial notification method (mode) and at least one alternate notification mode. However, the current state of the art in notification does not take into account performance metrics of a communication system, for a notification, before using that system. Electronic communication systems are known to have one or more metrics with regards to performance. Not all systems have the same set of metrics. A broad list of metrics include, but is not limited to, capacity, current usage, signal-to-noise ratio, error rate, echo, distortion, latency through the system (delay and jitter), availability, knowledge of powering sources and their performance, remaining battery duration when on battery power, etc.

The single most inherent problem with communication systems today is that out of economic necessity service providers (telephone companies, Internet service providers, etc.) significantly over-subscribe their networks. For example, a typical telephone Central Office (CO) has an over-subscription model of approximately 10:1. That is, there are 10 times more telephone numbers provisioned in any given CO than its call capacity. For example, if there is an local wide-spread emergency (e.g. an earthquake), and everyone with a phone number wants to make a phone call at the same time, only 10% of them can make a call while the other 90% do not get service (dial tone). A mass notification system that is not aware of the load state of the local phone system may fail to get the notifications out in a timely manner.

Another problem seen with the increase in attention to homeland security is the lack of focus on individual citizens being able to better prepare community response in their favor. More specifically, citizens are not being empowered to tailor mass notification, nor better prepare Emergency Responders to help them. For example, Emergency Responders are not informed with previously supplied information by citizens so as to be better prepared to help save the life of those citizens. Citizens need mechanisms for ensuring “best” Emergency Responder preparedness when responding to future emergencies that involve those citizens or their families.

It is becoming more evident that the best emergency preparation comes through the participation in emergency drills at many levels, from individuals to communities to counties, etc. To date, there is no system that can tailor drill results based on pre-existing collected information, nor couple results from the drill directly back into collected information.

Another factor today is that computers are everywhere. Due to the proliferation of personal computers, the widespread acceptance of the Internet and the World Wide Web, and the advent of the Information Age, there is a virtual explosion in the amount of digital data exchanged throughout the world. At home or at work, people now enjoy either Digital Subscriber Line (DSL) or Cable modem networking mechanisms that achieve better and faster Internet access than traditional dialup limits. Cable modems and DSL modems are chiefly responsible for increasing the speed of Internet access for homes and businesses. In parallel to the massive deployment of high-speed data services, users are now enjoying tetherless access via several wireless standards, notably those of the Institute of Electrical and Electronic Engineers (IEEE) Local Area Network (LAN) and Metropolitan Area Networking (MAN) standards collectively known under IEEE 802.11 label. The world is experiencing an explosive growth in consumer wireless networking access.

The observed primary behavior pattern to date has chiefly been that of exploiting the immediacy of on-demand access. That is, the user wants to view a web page “now!” or a user wants to buy something “now!” or the user wants to manage their finances over the web “now!” In many cases, the Internet has become more popular than direct access to real people: i.e., the bank teller, the store clerk, the Internal Revenue Service employee, etc. Along with the heightened use of both on-line financial services, shopping, interpersonal communications, and the like, there has been the increased exploitation of Private Information for criminal gain (i.e., identity theft) and the notable invasion of personal privacy through hackers, spam email, viruses, worms, trojans, spyware, adware, rootkits. More privacy and property invasions are being perpetrated as the Internet socializes into more widespread use, including but not limited to physical property theft, notably theft of portable laptop computers storing Private Information about many citizens.

The privacy invasion issues mentioned above have created a growing public apprehension that is severely limiting the full socialization of network-based services and applications that will greatly benefit individuals. These applications are only significant when having access to Private Information is assured and public confidence is attained. Until then, as the Internet moves ahead with its growth in on-demand services, this significant gap in public trust restricts usage.

Taking all the above into account, what would be very valuable to communities is a mass notification system that is both trusted and dependable. It would desirable if the system could be initiated by a sophisticated automated agent, or an authorized person. Flexible granularity of notification would be further desirable, i.e., different types of classes of notifications going to different recipients. It would also be desirable if such a system that could take advantage of various modes of delivery to achieve reliable delivery within performance expectations. It should be able to sense the performance of the selected delivery channels, and adapt to overloads in the delivery channels by offloading the notifications to alternate channels. In support of better citizen involvement and preparedness, a sophisticated proactive support system that is coupled into community Emergency Responder systems would be extremely valuable to communities. Such a system would enable citizens to improve future Emergency Responder effectiveness. Such a system would also enhance preparedness through the use of drills. With such a system in place, support could also be extended to proactively link life saving information from other local, state, and national resources.

### SUMMARY

According to some embodiments of the present invention, a Proactive Repository functions as a system for helping individuals, families, businesses, and communities to be more prepared when responding to emergencies. The Proactive Repository empowers people, businesses, and local governments to securely store different types of information in electronic form bonded to a set of rules that delineate when and to whom any portion of their information may be released in the future. In addition to personal and private information, additional safety-related information can be stored and kept up to date for helping Emergency Responders be more effective when responding to and arriving at a the scene of an emergency.

To ensure the system is trusted, the Proactive Repository also includes various levels and types of security and authentication to ensure that only authorized parties can enter information, that only authentic triggers and conditions can cause information to be released, that only authenticated parties receive information, and that information is only released in the proper manner as originally specified by the authorized party. All or a portion of authentication verification and information validation may be provided by third party services.

In some embodiments, information released from the Proactive Repository can be delivered to individuals, groups, or businesses, via any available communications device, as a facsimile, electronic mail, mobile phone text message, pager, voice message, via telephone, radio, the Internet, or other telecommunications systems. The Proactive Repository can make use of any communications system in existence, but does not depend on any one system.

The Proactive Repository overcomes the inherent limitations of previous mass notification systems, for example by uniquely examining performance aspects and operating criteria of a communications system. If the performance of the system is inadequate, the Proactive Repository uses at least one alternate communications system to increase the assurance of delivery within performance requirements. This multi-modal mechanism of notification is provided according to some embodiments of the present invention. In some embodiments, examination of performance aspects of the notification mode can be determined empirically or by information made available by the mode provider, e.g. PSTN network management system (NMS).

According to one embodiment, Entities can tailor their notifications and enter communication systems order preferences (e.g., use PSTN-based telephone first, electronic mail second, etc.) for notifications that include life saving alerts, such as tornadoes, hurricanes, flood stage changes, imminent levy or dike breach, missing persons, EAS, etc. In addition, non-emergency notifications can also be disseminated by the same or other communication systems order preferences. The Proactive Registry can also act as an agent for the individual, and subscribe or unsubscribe to national and regional information lists, as well as opt out of telemarketing calls via state and federal registries, etc.

In some embodiments of this invention, the Proactive Repository controls the rate of delivery of notifications for a preference node based on knowledge regarding the performance of the mode. In some embodiments of this invention, the Proactive Repository determines adaptive changes in response to changing conditions or situational analysis, as well as refinement of persistent models to promote learning. Such processing may be performed in real-time or may be included as part of routine maintenance. In another embodiment, Private Information in the Proactive Repository relating to residences containing life support equipment is securely released to at least one authentic Entity by a change in status condition relating to a condition change in that equipment or a change in a public utility service (e.g., a power failure). In some embodiments of this invention, the Proactive Repository facilitates Remote Access for Emergency Responders and other authentic Entities. In some embodiments of this invention, the Proactive Repository facilitates interactive Public Access. In some embodiments of this invention, the Proactive Repository is configured as an Information Valet. Based on criteria established by a sending Entity or by a receiving Entity, information submitted into the Information Valet is processed, optionally stored, and made available to a receiving Entity either by notification or by remote access. In another embodiment, Private Information in the Proactive Repository relating to the authenticated identification of a person is securely released to an authenticated third party by the authenticated action of an Entity responsible for that Private Information.

The features and advantages described in this summary and in the following detailed description are not all-inclusive, and particularly, many additional features and advantages will be apparent to one of ordinary skill in the relevant art in view of the drawing and specification hereof. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a block diagram illustrating the high level functional architecture of a Proactive Repository, according to some embodiments of the present invention.

FIG. 2 is a state diagram of a Proactive Repository system according to some embodiments of the present invention.

FIG. 3 is a flow chart illustrating steps for a per-Entity multi-modal notification process, according to some embodiments of the present invention.

FIG. 4 is a state diagram illustrating the overall notification process, including adaptive learning, according to some embodiments of the present invention.

FIG. 5 is a state diagram illustrating an information maintenance process of the Proactive Repository including adaptive modification of the information gathering processes, according to some embodiments of the present invention.

FIG. 6 is a block diagram illustrating the high level functional architecture of a Proactive Repository configured as an Information Valet, according to some embodiments of the present invention.

The Figures depict embodiments of the present invention for purposes of illustration only. One of ordinary skill in the relevant art will readily recognize from the following discussion that alternative embodiments of the structures and methods illustrated herein may be employed without departing from the principles of the invention described herein.

### DETAILED DESCRIPTION

According to various embodiments of the present invention, systems and methods store information containing both public and Private Information, and associate a set of criteria that controls the authority of information sources, as well as the criteria by which said information can be released and what set of at least one recipient can receive the information.

As used herein, the following terms have the following meanings:

“Entity” refers to a distinct and separately identifiable specimen. For example, an Entity may be a person, a public or private service (e.g., Emergency Responder service such as police, fire, ambulance, paramedic, electric utility company, etc.), business, service provider, special interest organization (of which there are many types, for example, but not limited to, club, church, temple, lodge, fraternal group, social service group, etc.), electronic device, or Sensor. An Entity can be a participant in a Proactive Repository as either a distinct source of information, a distinct recipient of information, and/or an administrator of information and policies. An Entity can be uniquely authenticated and authorized with a Proactive Repository.

“Role” refers to a set of capabilities assigned to an Entity for access to a specific Proactive Repository. Different Roles are granted different access rights, such as read-access, write-access, modify, copy, or delete, as well as access to all or a portion of the information stored in said Proactive Repository.

“Primary Entity” refers to at least one Entity responsible for the input and maintenance of Private Information. For example, in the case of a single-family residence, Primary Entities will likely be the head or heads of a household, or an authorized agent thereof.

“Public Entity” refers to at least one Entity responsible for the input and maintenance of stored Public Information.

“Release Entity” refers to at least one Entity responsible for the input and maintenance of Release Policy Information. For example, a Primary Entity may also be a Release Entity for maintaining the Release Policy Information of the Private Information of said Primary Entity.

“Tangible Property” refers to property capable of being precisely identified or realized as well as typically being capable of being appraised at an actual or approximate value. Tangible Property includes, but is not limited to, property owned by at least one Primary Entity, such as real property and chattels, buildings, vehicles, valuables, livestock, furnishings, and legal instruments having value such as stock, bonds, and other monetary assets, etc.

“Release Policy Information” refers to a collected set of policies, associated criteria, and/or processes that determine the actions of the Proactive Repository for causing the release of information to at least one authorized Entity. Release Policy Information determine the terms of release of any type of information stored in the Proactive Repository, such as but not limited to Public Information, Private Information, Release Policy information, and other types of information that may be stored in the Proactive Repository. Release Policy Information includes, but is not limited to, at least one specification of action originating from a Dispatcher, a Primary Entity, an Electronic Agent representing a pre-determined and authenticated Entity, or directly or indirectly from information received via a Global Telecommunications Network from at least one sensor.

“Dispatcher” refers to a person or set of persons, or automated equivalents, responsible for notifying and calling to action at least one public safety service such as but not limited to police, fire, paramedic, ambulance, Coast Guard, and Homeland Security, etc. The scope of a Proactive Repository may but need not be broader than that of a single municipality, and may include scopes covering, county, state, country, continent, planet, solar system, etc. In cases of broader scope, a “Dispatcher” is responsible for calling to action at least one emergency response service appropriate to the Release Event and the scope covered by said Release Event.

“Emergency Responder” refers to an authorized person or set of authorized persons from at least one public or private safety or law enforcement organization such as but not limited to police, fire, paramedic, ambulance, Coast Guard, Homeland Security.

“Release Event” refers to a pre-determined event, specified in the Release Policy Information, which initiates the release of information to an authorized recipient. Such events may be automatically initiated, such as in the case of a residential home fire alarm system that provides a means for electronic communications with the Proactive Repository or in the case of environmental sensors indicating an event such as a creek having reached critical flood stage; or may be manually initiated by an Entity authorized by the Release Policy Information (e.g., a Dispatcher), or may be manually initiated by a Primary Entity. A Release Event can also initiate a Primary Entity notification event, whereby information can be disseminated to at least one set of Primary Entities with information stored in the Proactive Repository. For example, information about an impending natural disaster can be proactively disseminated via the Proactive Repository. A Release Event can but need not span input from many different types of either automatic and/or manually initiated events or conditions.

“Public Information” refers to information that comes from at least one public source, such as, but not limited to, property parcel information, building permits, U.S. Geographic Survey information, satellite photos, published name, address, and phone number information, etc. Any information that is publicly available is Public Information.

“Private Information” refers to information that is generally considered private and of concern to a Primary Entity. Private Information includes, but is not limited to information regarding the individual or members of their family, including individual particulars relating to identification, personal status, or Tangible Property, such as but not limited to photographs, fingerprints, voice prints, medical information, life-support equipment, bank account numbers, identification numbers, account passwords, social security numbers, etc., as well as bedroom location and occupancy, gate access codes, etc. Private Information can also includes electronic monetary instruments and equivalents, such as but not limited to electronic stock, electronic cash, electronic wallets, etc. and actions or systems associated with such instruments, such as but not limited to, electronic payments, electronic micro-payments, conversion instructions and conditions, purchase instructions and conditions, transfer instructions and conditions, etc. Private Information also includes information that is in the public domain but may not be released for reasons of privacy. For example, the phone numbers of residents including the association to name and address may be known to the local government, but may not be releasable to the public.

“Public Utility Information” (hereafter “Utility Information”), refers to information concerning the topological deployment of public and private utility infrastructure and systems, including but not limited to: electrical utility power distribution systems (e.g. distribution plans, grid inter-tie systems, sub-stations, generation facilities, etc.), water system distribution (e.g. pipelines, sewer lines, aqueducts, viaducts, pump houses, wells, dams, waste processing plants, etc.), cable company distribution networks (e.g., head end, main feeder lines, nodes, distribution hubs, etc.), and telephone systems (e.g., central office, remote terminal cabinets, distribution lines, fiber optical cable distribution and hub locations, mobile/cell site infrastructure locations, etc.). Some geographic areas may have additional utilities, such as flood control and pumping systems, etc. While in the general sense, some Utility Information is publicly viewable, e.g., power lines on poles, etc, the comprehensive collection of such information will be of a private nature and control. Therefore, the use of term Utility Information will include the use of both Public Information and Private Information.

“Authentication and Authorization” refers to at least one available mechanism or practice to uniquely and accurately authenticate the identity of an Entity, and subsequently assign to that authentic Entity at least one access right regarding contents stored in the Proactive Repository. Such rights include, but are not limited to, read-access, write-access, create, modify, delete, database schema maintenance, backup, restore, copy etc. In addition, access capabilities may be assigned to all or a subset of data stored in the Proactive Repository. For example, a backup operation Entity could require backup access to the entire Proactive Repository, while the access of a Primary Entity could require at minimum read, write, create, modify and delete capabilities for their Private Information. An authentic Entity is one that has been granted access to all or a portion of the information in the Proactive Repository based on the results of authentication and authorization.

“Limited Authorization” refers to a feature of the Proactive Repository, to allow a first Entity to create a tailored set of access rights to all or a subset of said first Entity's Information, or to all of or a subset of access rights to the Proactive Repository, and then to grant or give said tailored access rights to at least one second Entity. Said tailored set of access rights become associated to and cohered to the Proactive Repository for that first Entity and/or second Entity. The Limited Authorization will continue in effect until said first Entity modifies or deletes said tailored set of access rights.

“Temporary Authorization” refers to an extension of Limited Authorization such that the grant of a tailored set of access rights do not become enabled until at least one event transpires, such as a date and/or time, or an event specified in the Release Policy Information. Furthermore, the disabling of Limit Authorization can be specified to occur when at least one event transpires, such as date and/or time, or based on an event specified in the Release Policy Information.

“Global Telecommunication Network” refers to at least one network (typically but not necessarily electrical and/or electronic) that provides communication services between a sender of information and a receiver of information. Such networks include the public telephone network, the public mobile telephone network, the public Internet, other public networks, and future similar networks regardless of scope or domain. An example would be a future space-based telecommunications network connecting the Earth with other celestial bodies or spacecraft, etc. regardless of location. For the purposes of this application, Global Telecommunication Networks also refers to private networks regardless of size or implementation, that have the characteristics of providing or permitting communication services between at least one sender of information and at least one recipient of information. As will be apparent to one of ordinary skill in the relevant art, depending on regional context, a mobile telephone network may be called a cellular telephone network.

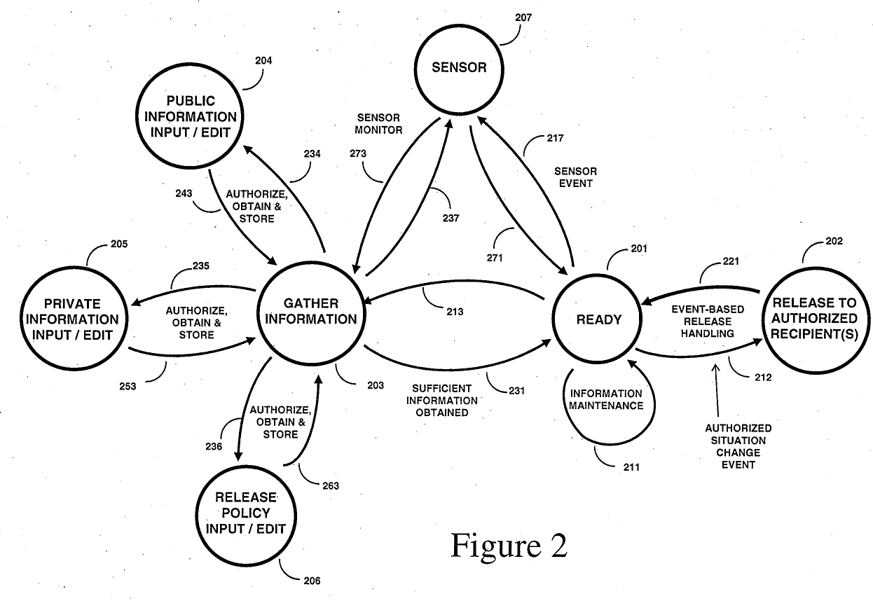

“Certified Repository Ready” (CRR) refers to the condition when the Proactive Repository is in the Ready state (illustrated in FIG. 2) for an Entity. CRR indicates the thoroughness (completeness) condition of the information collected from an Entity or Entities. Different types of Entities may be configured with different CRR conditions. For example, an Entity who resides in a single family dwelling may have different requirements than an apartment Tenant, etc. CRR may be minimally tested with the condition response of “True” (Complete) or “False” (not Complete) or may be made visible via a more complex set of conditions. The CRR condition can be made available to at least one authorized monitoring Entity.

“Electronic Agent” refers to a Global Telecommunications Network accessible service that acts on behalf of an authorized Entity. An Electronic Agent is a participant in the Proactive Repository as either or both a distinct source of information or as a distinct recipient of information. An Electronic Agent has the characteristics of being uniquely authenticated and authorized and uniquely bonded to a responsible Entity. An Entity may have none, one, or more Electronic Agent(s) operating on its behalf. Various network services exist today which can form part of an Electronic Agent, and may be implemented as web portals, application service ports, etc., as well as stored or temporarily located on at least one portable device, such as but not limited to “smart” cards, other active cards, mobile telephone SIM cards, subcutaneous devices, implants, smart “dongles”, etc. It is likely that an Electronic Agent would typically be authenticated and authorized with the Proactive Repository in accordance with the policies specified by the Release Policy Information.

“Sensor” refers to an electronic or other type of device that in at least one form measures conditions and/or events, such as temperature, moisture, motion, airborne particulate composition and concentration, vibration, humidity, pressure, light spectrum composition, illumination level, radio frequency detection, presence of certain gases or chemicals, elements etc. In another form, a Sensor measures biological and/or biometric conditions, such as body temperature, breathing rate, pulse, oxygen saturation in the blood, carbon dioxide and oxygen content of gases exchanged during inhalation and exhalation, electrocardiogram information etc. In another form, Sensors measure conditions as a remote extension to human senses, such a video for sight, microphones and other acoustic measurements for hearing, pressure sensors for touch, etc. Sensors may also be combined with other Sensors and their measurements combined. For the purposes of this application, a Sensor performs measurements and communicates information about those measurements via a Global Telecommunications Network directly or indirectly with a Proactive Repository. Sensor information may also be communicated to the Proactive Repository via an authenticated Electronic Agent.

“National Emergency Alert System” (hereafter EAS), refers to the a national communication system, and its future successor systems, that have been or will be deployed in a country, such as in the United States, for the dissemination of emergency information and instructions that can have national, state, or local significance. The United States EAS system has been typically used to disseminate information through national, state, and local broadcast facilities, such as broadcast and cable television and broadcast and cable radio. The type of information included in the existing system can include the originator of the information (e.g. the radio station call sign), the areas included in the alert (e.g., national, state, county, etc.), the type of emergency (e.g., Presidential or Government Notification, flood, AMBER missing child alert, etc.) and a textual or voice description of the emergency, such as but not limited to, a flood and the mention of the river and the expected time of crest, or an AMBER missing child alert with a text or voice description of the abducted child, the location, information about the abductor such as a car license plate number, description of the suspects and/or their car, etc. In the United States, a missing child alert is called an AMBER alert (see www.amberalert.gov). There are many EAS alert types. In the United States, the President recently ordered enhancements to the EAS system to include web-based access for registering for EAS event notifications, as well as enhanced distribution of EAS information to portable personal devices and electronic mail services. For the purposes of at least one embodiment of this invention, a National Emergency Alert System also includes a Multi-national Emergency Alert System. That is, one alert may be sent for distribution to countries that may be impacted by a shared event. For example, a Pacific Ocean tsunami can impact the coasts of many countries and an alert from a regional weather station can be sent to the possibly affected countries simultaneously.

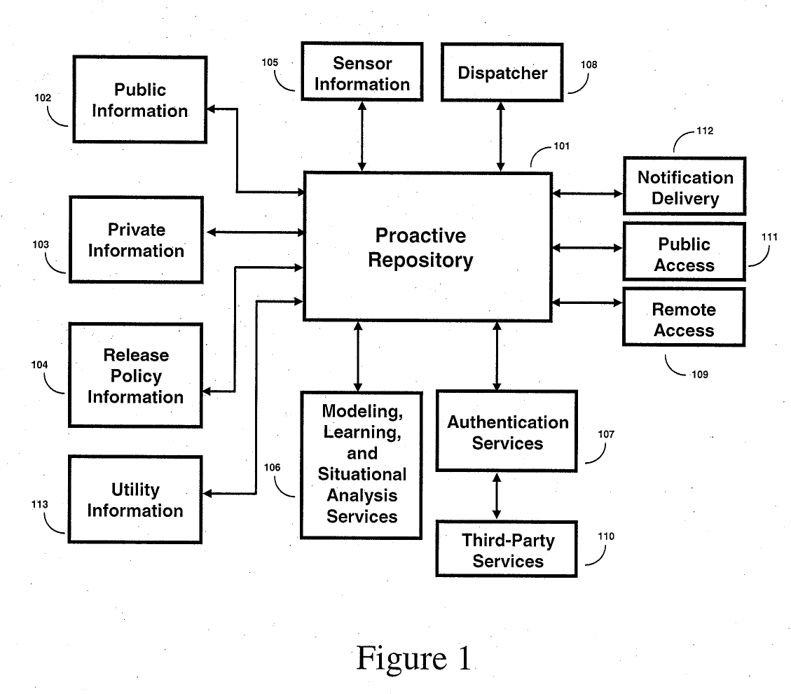

FIG. 1 illustrates a Proactive Repository 101 system, according to some embodiments of the present invention. In one such embodiment of the present invention, access capabilities for Private Information 103 and Public Information 102 are authorized, delegated, obtained, stored, updated, and assigned. The Authentication Services 107 function determines the authorization of an Entity and their subsequent access rights, once the Entity has been deemed authentic. Access capabilities are configured such that the Public Information 102, and/or Private Information 103 is made accessible/distributed according to Release Policy Information 104, responsive to the occurrence of at least one of a previously defined set of events (e.g., input from a Sensor Information 105, an action of a Dispatcher 108, a trigger generated by Modeling, Learning, and/or Situational Analysis Services (hereafter MLSA Services) 106, etc.). For example, a Private Entity can use the Private Information 103 function to enter and manage their Private Information 103 in the Proactive Repository 101. The Private Entity can also use the Release Policy Information 104 function to enter and edit Release Policies. The stored information is only made available to other authentic Entities, according to the Release Policy Information 104.

One example of such a process is that recipient-specific information is retrieved and made available via Notification Delivery 112 to a Response Entity prior to that Entity's response to and resolution of said Release Event. Said Response Entity may be granted further Remote Access 109 capabilities to information in the Proactive Repository 101. The Dispatcher 108 function includes other official input and control capabilities, such as but not limited to Public Information Officer (PIO), Emergency Operation Center (EOC), etc. Authentication Services 107 may be implemented all or in part by a Third-Party Services 110 provider, such as but not limited to a verification and authentication service, a government authentication system, etc. Access provided to Third-Party Services 110 may include only authorization and authentication services, or may be extended to validate all or portions of the existence or content of information that is contained within the Proactive Repository 101.

Another information source for the Proactive Repository 101 is the Utility Information 113 function that facilitates the exchange of information between a Public Utility and the Proactive Repository 101. For example, power outage events can be sent from the local electric company to the Proactive Repository 101.

It is to be understood that various functions associated with the Proactive Repository 101 may be supplied in whole or in part by services provided by third-parties. In addition, MLSA Services 106 may be interconnected via at least one Global Telecommunications Networks to other MLSA Services 106 as well as to other Proactive Repositories 101. Such third-party interconnections can provide a broader set of knowledge and learning, as well as facilitate situational analysis of large events that overlap multiple territories served by at least one Proactive Repository 101. For example, floods, tornadoes, earthquakes, and other widespread natural disasters frequently involve more than one municipality, etc. Other situations in which shared MLSA Services 106 is warranted will be apparent to one of ordinary skill in the relevant art in light of this specification.

Different functions can be grouped behind one or multiple user interface(s). For example, a Private Entity may edit, modify, etc. both their Private Information 103 and Release Policy Information 104 using the same user interface.

In some embodiments of this invention, the Proactive Repository 101 facilitates Remote Access 109 for Emergency Responders and other authentic Entities. Such access can provide real-time updates to incident conditions. Remote Access 109 can also provide other support in the form of access to local and government health and safety related information services. These services may be enhanced by the Proactive Repository's 101 continual situational analysis of the incident as well as timely post-incident closure and follow-up.

In some embodiments of this invention, the Proactive Repository 101 facilitates interactive Public Access 111. This function provides access to Public Information 102 made available by the Proactive Repository 101, for example via a web page interface, or for other routine public access needs. In another embodiment, an authorized Third-Party Services 110 agent can validate that the Public Information 102 and/or Private Information 103 for a location has been entered into the Proactive Repository 101, as well as identify the Entities authorized to make changes to the Proactive Repository 101 for said Private Information 103. In yet another embodiment, an authorized Third-Party Services 110 agent can validate the authenticity of an Entity's credentials for having access to managing either Public Information 102 or Private Information 103 in a Proactive Repository 101.

It is to be understood that although various components are illustrated in FIG. 1 as separate entities, each illustrated component represents a collection of functionalities that can be implemented as software, hardware, firmware or in any combination of software, hardware, and firmware. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

Turning now to FIG. 2, a state diagram is representative of a method according to one embodiment of the present invention. The initial state is Gather Information 203. In this state, the Proactive Repository 101 is waiting for information to be gathered. When Public Information 102 is to be gathered, the state changes 234 to Public Information Input/Edit 204. Public Information is gathered, and after authorization for obtaining the data, it is stored and the state returns 243 to Gather Information 203. When Private Information 103 is to be gathered, the state changes 235 to Private Information Input/Edit 205. Private Information 103 is gathered, and after authorization for obtaining the data, it is stored and the state returns 253 to Gather Information 203. When Release Policy Information 104 is to be gathered, the state changes 236 to Release Policy Input/Edit 206. Release Policy Information 104 input is gathered, and after authorization for obtaining the data, it is stored and the state returns 263 to Gather Information 203. If and when the minimum conditions set forth in the Release Policy Information 104 are met, the state moves from Gather Information 203 to Ready 201. In this state, the Proactive Repository 101 is ready to release information upon the occurrence of at least one pre-specified Release Event. Upon receipt of a Release Event 212, the state changes to Release to Authorized Recipient(s) 202. In this state, information is released to at least one authorized recipient for the pre-specified event, according to the policy or policies specified during Release Policy information gathering 206. After information is released, state returns 221 to Ready 201. For maintenance, update, and other analysis processing of information, the state changes from Ready 201, executing the maintenance procedure 211, and returns back to Ready 201. Note that this implementation depicts a maintenance procedure that does not take the Proactive Repository 101 out of the Ready 201 state. If the updated information continues to meet the requirements for being Ready 201 state remains in Ready 201. If the conditions are not met the state changes 213 to Gather Information 203 while new information is being added and/or previous information modified. If new information meets the Release Policy or policies, the state changes to Ready 201, otherwise, the state remains in Gather Information 203. If the Proactive Repository 101 is configured to use at least one Sensor 207 providing Sensor Information 105, the system can monitor the operation of the Sensor 207 via 273 and 237 via the Gather Information 203 process. In addition, the Sensor 207 can update Ready 201 state information via 217 and 271 that may result in an Authorized Situation Change Event 212. Although not illustrated in FIG. 2, Gather Information 203 exchanges information with Utility Information 113.

It will be apparent to one of ordinary skill in the relevant art in light of this specification that there are many possible variants of the states depicted in FIG. 2 that can be instantiated according to various embodiments of the present invention. It will also be apparent to one of ordinary skill in the relevant art in light of this specification that the Release to Authorized Recipient(s) 202 may include a temporal window of availability, such that authorized Entities may access information over a period of time, for example, during the entire time an incident is active, including post activation closure processes. Other embodiments of this invention may also allow access to Private Information 103 that has some relationship with the first release of information. One of ordinary skill in the relevant art will also note that certain Private Information 103 may be obtainable and preloaded by the local municipality without requiring a first entry by a Principle Entity. Such information may include, but is not limited to, phone numbers for at least a portion of residents, their names, and addressees.

Returning to FIG. 2, as part of an embodiment of this invention, Release to Authorized Recipient(s) 202 may also allow the release of other information that is spatially related to the first information that is released. For example, an Emergency Responder may need information about at least one property adjoining the first property to which they were originally dispatched. Many Emergency Responders will have computers with wireless access at the scene of the emergency and can readily access additional information. One of ordinary skill in the relevant art will note that other relationships that trigger the additional release of information may be implemented in other embodiments of this invention.

In one embodiment, this system provides a means by which highly personal and sensitive information can be stored electronically. Such information can comprise anything that can be put into electronic form, for example, medical records, pictures of the family (e.g. children, parents, grandparents, pets, etc.), serial numbers and photographs of property, vehicles, livestock, etc. In addition to personal information, other safety-related information can be stored and kept up to date for helping Emergency Responders to be more effective when arriving at a family's home during an emergency. Information such as location of utility shutoffs, which rooms are the bedrooms of the various occupants, names and pictures of occupants, current medical conditions of occupants, location of hazardous materials, condition of the property, etc. can be included.

A family can also specify a set of policies that govern how the Proactive Repository 101 can release any portion of that information, and to whom that information can be released. For example, activation by an Emergency Dispatcher 108 could cause the release of information that pertains to Emergency Responder effectiveness, as mentioned previously. Other kinds of information can be stored, such as use of life sustaining medical equipment (e.g., oxygen concentrators, etc.) and operative details such as power required, duration of reserve power available on batteries, etc. In the event of a power failure, the Emergency Dispatcher 108 could be provided with a prioritized report detailing, for example, which residents need immediate assistance for their medical equipment maintenance and operation, or which need to be transported to a local medical facility. The Proactive Repository 101 also enables Emergency Responders and communities to create tailored questionnaires, forms, etc., for helping individuals and families provide needed information. Proactive repository 101 operations for supporting businesses are similar to those for supporting individuals and families. The Proactive Repository 101 can provide collection and storage of information to help in emergency preparedness and response in any capacity.

In one embodiment, the Proactive Repository 101 is used to collect and collate Public Information about residences or other structures of long term dwelling (e.g., single and multiple family dwellings, multiple dwelling units, assisted living facilities, convalescent homes, retirement communities, dormitories, fraternity and sorority houses, etc.). The location and contents of buildings, the location of utility shut off mechanisms, and the location of on-site responder equipment (e.g., a gasoline powered pump for use with water in residents pool or pond for firefighting) can also be stored. In addition, information regarding known hazards (e.g., an open well) can also be stored and the information made available to Emergency Responders.

In addition, Private Information 103 concerning individual family members can be collected and stored in the Proactive Repository 101. Such information can include, for example, photographs, fingerprints, voice prints, medical information, life-support equipment requirements, etc., as well as bedroom location and occupancy, etc. Such information is collected from authorized Entities (e.g., persons, agencies, businesses) and stored in the Proactive Repository 101. In addition, associated policies and criteria dictate under what circumstances such information can be released from the Proactive Repository 101 and to whom such information can be released. For example, the information can be released responsive to an action of an Emergency Dispatcher 108 responding to the notification of a critical event (e.g., 911 call in North America, or 112 call in the European Union), to at least one authorized Emergency Responder safety service agency (e.g., fire, police, ambulance, emergency room, etc.) responding directly to or responsible for a situation or condition

According to one embodiment of this invention, at least a portion of Private Information 103 from at least one first Private Entity may be merged with at least a portion of Private Information 103 from at least one second Private Entity. The combined Private Information 103 can be released to at least one authorized Entity. For example, suppose the landlord or owner of a Multiple Dwelling Unit (MDU), e.g., an apartment building, has stored Private Information 103 in the Proactive Repository 101 which describes the MDU property, such as but not limited to physical descriptions, emergency water manifold locations, utility shut off valve locations, local electrical (e.g. generator) shut offs, apartment layouts, emergency exits, floors, stairways, elevator locations, hazardous material locations, etc. A complete survey, for example, may be termed “what is behind every door.” In addition, suppose the landlord has created a set of at least one Limited Authorizations which permit the tenants in that apartment to make all or a part of the MDU information available to Emergency Responders. The Private Information 103 of each tenant Private Entity details information that is of a private nature to the tenant, e.g., family members, sleeping rooms, medical conditions, photographs, etc.). Under such a scenario, an emergency 911 call regarding one of the tenants would result in the release of Private Information 103 from both the tenant and the landlord to the Emergency Responders. In another example, Private Information 103 from a home owners association could be merged with the Private Information 103 of individual homeowners within the association. Said Private Information 103 may also include any applicable Covenants, Codes and Restrictions (CC&Rs). As will be apparent to one of ordinary skill in the relevant art, these examples are just a few of many scenarios supported by the Proactive Repository 101 for the release of authorized information to at least one Entity that contains merged Private Information 103 from Private Entities.

As a further example, a college or university is the owner and manager of dormitory housing. A college or university may further manage fraternity and sorority houses. In these cases, the institution can store information in the Proactive Repository 101 describing what is behind every door for Emergency Responder and institutional use. The institution can then create limited authorizations for each student, floor monitor, house monitor, etc. to be used while the person is dwelling in the housing. In another example, the institution can assign a Proactive Repository 101 for each student at the institution, and then each Proactive Repository 101 can be associated with the Proactive Repository 101 which describes the housing. One embodiment of the present invention permits different configurations of storage, content, and association of Proactive Repositories 101. One of ordinary skill in the relevant art will note that these examples can be applied to MDU use as well as college and university use.

The use of Proactive Repositories 101 for describing what is behind every door extends to other forms of structures and dwellings. In another example, the Proactive Repository 101 can make available national information sources, such as that of the United States National Institute of Health (NIH) and the National Library of Medicine (NLM) WISER (Wireless Information System for Emergency Responders, wiser.nlm.nih.gov) system for providing detailed information about hazardous materials. An Emergency Responder with access to the “behind every door” information is better informed, allowing more effective and safe response. One of ordinary skill in the relevant art will note that this coupling of information is unique to the Proactive Repository 101 and can be extended to other enhanced situational awareness support scenarios.

As part of this embodiment, either all or a subset of Public Information and/or Private Information 103 from a first Entity can be flagged by a second Entity as a form of feedback. The semantics of the flagging are established by an Entity responsible for the administration of the Proactive Repository 101. The flagging can but need not include an annotation providing more information about the flagging. The action of flagging can but need not result in a notification being sent to said first Entity. For example, an Entity inputs information describing various aspects of their dwelling (e.g., number of rooms, color of house, location of utility shut off values, etc.). Upon responding to an event at the property, an Emergency Responder causes the information about the dwelling to be updated with the annotation in the Private Information 103. For example, the windows now have bars on them which is contrary to the existing description; or the color of the dwelling is not the same as described; or there is a covered well in the backyard, etc. According to one form of semantics of flagging, the Dispatcher 108 performs the flagging and annotation. A notification is then sent to said first Entity, requiring that said first Entity update their Private Information 103. As will be understood by one of ordinary skill in the relevant art in light of this specification, these examples use flagging and annotation within the Proactive Repository 101 as a means to communicate information inaccuracy notices to the Entity responsible for said information. Flagging and annotation capability may also be used to support other services within the Proactive Repository 101.

In some embodiments, all or a subset of first information in the Proactive Repository 101 is flagged and annotated by a first set of Emergency Responders or by the Dispatcher 108. Said flagged and annotated information is retained in the Proactive Repository 101 and made available to a second set of Emergency Responders that can but need not include the first set of Emergency Responders.

In some embodiments, information is entered into the Proactive Repository 101 by a first Entity. The Proactive Repository 101 holds the entered information for review by a second Entity. Said second Entity reviews this information and either approves or disapproves of its entry into the Proactive Repository 101. Upon approval by said second Entity, the information is formally entered into the Proactive Repository 101 and made available for use. Upon disapproval by said second Entity, the information can but need not be deleted, and a corresponding notification can but need not be sent to said first Entity. As will be apparent to one of ordinary skill in the relevant art in light of this specification, other methods and approval architectures can be utilized in other embodiments of the invention.

According to one embodiment, a first Private Entity has previously stored information in the Proactive Repository 101. Sometime in the future, a second Private Entity authenticates, is authorized and accesses the information from said first Private Entity. Said information may be subject to at least one action, such as but not limited to updating, resetting to default values, or deleting, allowing said second Private Entity to become the Entity responsible for this second information. For example, the authentication and authorization used by both said First Entity and said Second Entity can be based on establishing the legitimate use of a billing address to authenticate and authorize access for a dwelling. This may happen when the new owner of a home updates information in the Proactive Repository 101 that was originally input by the previous owner. This may also happen when a new tenant starts a lease for a new dwelling rental (e.g. house, apartment, etc.) and updates the information entered by a previous tenant. Said first information can be retained in the Proactive Repository 101. Said first information can be made available along with said second information to Emergency Responders.

In some embodiments, a Private Entity stores additional information in the Proactive Repository 101 that is not subject to disclosure to an Emergency Responder. For example, a Private Entity can enter Private Information 103 into the Proactive Repository 101 that includes, but is not limited to, any financial account information, (e.g., login identification and passwords), Social Security Administration information, life insurance information, personal computer access information, and any other form of private information. Said information is stored for later retrieval by the Private Entity, and can be released to other Entities according to the Release Policy Information 104 for said Private Information 103.

In some embodiments, as a result of a Dispatcher 108, Emergency Responder, Electronic Agent, or other event described in the Release Policy Information 104, notification information may be distributed to at least one authorized Entity comprised from the set of all Private Entities whose Private Information is stored within the Proactive Repository 101. Such notification may be disseminated using at least one notification mode, such as but not limited to, electronic mail, mobile telephone Short Message Service (SMS), pager, telephone call, or other mechanism that transfers or transmits information from a sender to recipient. For example, a Dispatcher 108 may initiate a flood warning notification. The Proactive Repository 101 will select zero or more Private Entities to receive the flood alert notification based on a set of selection criteria input by the Dispatcher 108 or specified within the Proactive Repository 101 (such as all residences that may be flooded by the event, etc.) The transmission of notifications is then initiated by the Proactive Repository 101. As will be understood by those of ordinary skill in the relevant art in light of this specification, this example is but one of many scenarios supported by the Proactive Repository 101 for the notification of at least one Entity.

In some embodiments, as a result of an activation of the EAS, the Proactive Repository 101 creates a notification and sends the notification to zero or more recipient Entities based upon Release Policy Information 104 specified by Private Entities. As a result of prior configuration, EAS-triggered notifications may have been automatically configured, or may have been configured by the action of a Private Entity that has expressed interest to receive notifications based on at least one EAS activation. In some embodiments, the Proactive Repository 101 is used to improve on the distribution of information activated by the EAS or by activation of other emergency notification systems.

In some embodiments, Private Information is made part of an EAS activation. For example, a Dispatcher 108 receives a 911 call detailing the abduction of a child. The Dispatcher 108 then accesses a photograph of the child in Private Information that has been previously stored by the responsible Private Entity (e.g., the parents). The Dispatcher 108 then initiates the process where the photograph is made part of the information for the subsequent missing child alert that is released in the EAS. As will be understood by those of ordinary skill in the relevant art in light of this specification, this example is but one of many scenarios by which Private Information can be released and made part of an emergency notification system, in original or processed form, such as the EAS.

In some embodiments, responsive to an activation, the Proactive Repository 101, either directly or indirectly via a third party Entity, processes Public Information 102 and/or Utility Information 113 to produce a set of affected Entities, and a corresponding notification of the event to be sent thereto. For example, a one hundred year flood event is about to take place by a creek that runs through a portion of the community. Public geographic, topological, street, and sewer information is processed to determine which Entities should receive a notification (e.g., at a minimum, those residences and/or other buildings that are in the local floodplain of the creek). As will be understood by one of ordinary skill in the relevant art in light of this specification, this example is but one of many scenarios by which Public Information 102, Utility Information 113, or other information can be processed to produce a list of a subset of Entities. In this example, the list created was for the notification of Entities based upon an emergency event. Other uses can include creating a list for reasons other than notification purposes. In addition, the processing can be initiated not only by an emergency event, but can also be initiated by, e.g., a Dispatcher 108 and/or Entity responsible for maintaining the Proactive Repository 101 system (e.g., backup, transfer of information, etc.).

In one embodiment, the Proactive Repository 101 acts as a portal to at least one personal security and/or personal notification service, based on Private Information that has been entered by a Private Entity. For example, the Proactive Repository 101 interfaces to the upcoming EAS notification website on behalf of the Private Entity. This allows the Proactive Repository 101 to be the Personal Information and Security Portal for the Private Entity. As will be understood by one of ordinary skill in the relevant art in light of this specification, the Proactive Repository 101 can act as a frontend to other Internet services or non-Internet services connected via a Global Telecommunications Network.

In some embodiments, Public Information 102, Utility Information 113, and/or Private Information 103 stored within the Proactive Repository 101 may be used for supporting emergency drill and training purposes. For example, information stored in the Proactive Repository 101 is flagged as being available for emergency drill and/or training purposes. Said information can be real (e.g., a real building may be used for the training exercise with the owner Private Entity flagging all or a subset of their Private Information as available for emergency drill and/or training purposes for an upcoming training event) or fictitious (e.g., a Private Entity has created at least one set of Private Information 103, Public Information 102, and/or Utility Information 113 whereby all or a subset of each is flagged as available for emergency drill and/or training purposes). For example, a neighborhood may elect to hold a disaster drill as part of enhancing neighborhood preparedness. A drill scenario is established within the Proactive Repository 101 for the event and tailored to create different emergency training situations, as well as record neighborhood responder action to these situations. Such situations may include, for example, premises with gas leaks that require inspection and simulated verified gas shutoff, an invalid requiring emergency power for life sustaining medical equipment requiring a local generator be brought to their dwelling, house-to-house checks and verification, location of and safety check of individuals known to have dementia or Alzheimer's disease, as well as road and utility status information.

In another example, each neighborhood participant in a preparedness drill could also provide a review checklist of their individual or family preparedness states, including available tools, first aid kits, immediate travel preparation kits, etc. A preparedness report could be provided back to the individual or family, and also be included as part of a neighborhood summary. For some drill results, such as the state of preparedness of an individual or family, the Proactive Repository 101 could move the results back into the non-drill information creating a report and a notification reminder that some attention needs to be given to the preparedness state for the individual or family. One of ordinary skill in the relevant art will note that existing information could be used to tailor or configure a practice drill and reversely, drill results can be used to augment existing, i.e., non-drill, information. One of ordinary skill in the relevant art will note that a formal drill is not required for an Entity to assess their emergency preparedness state. The Proactive Repository 101 can be used to provide continual feedback of emergency preparedness (e.g., in the form of scoring, through the use of routine Entity input, and their own assessment). The creation and scope of the drill can be set at any level of granularity, for example, to an individual Entity, a group of Entities, a neighborhood, a geographic area, the entire community served by the Proactive Repository 101, etc.

In some embodiments, all or a portion of all information contained within a first Proactive Repository 101 may be replicated or transferred within all or a part of a second Proactive Repository 101. Said replication may be automatic or manual. For example, a Proactive Repository 101 may be replicated to improve network performance or reliability. In another example, the replication may be used as part of a backup mechanism for said first Proactive Repository 101. In another example, all or a portion of said information may be transferred to a second Proactive Repository 101, such as in the case of a family moving to a new home and transferring previously stored private information to a second Proactive Repository 101 whose scope includes the family's new dwelling. In another example, a subset of a first Proactive Repository 101 for a large metropolitan area may be replicated in a second Proactive Repository 101. Said subset of information may contain information for a city within the metropolitan area where said second Proactive Repository 101 is located in the police station for that city. Such replication may contain all or part of the original source. Replication can be used for many reasons, such as backup, hot-standby, load balancing, disaster recovery, transfer, etc. The Proactive Repository 101 can have the property of supporting the authenticated and authorized replication and transfer of all or a subset of information.

In some embodiments, all or a subset of Private Information 103 may be replicated on a portable device under direction of the responsible Private Entity. Such portable devices include but are not limited to memory cards, portable Personal Data Assistants (PDAs), mobile (cellular) telephones, “smart” cards, Radio Frequency Identification (RFID) enabled devices, other embedded active devices, subcutaneous devices, body implants, etc. Said Private Information 103 can but need not include Release Policy Information 104 that have been bonded and cohered to said Private Information 103. Said Private Information 103 can but need not also include authorization criteria that has been bonded to and cohered to said Private Information 103 in addition to said Release Policy Information 104. For example, a Private Entity may entrust a second messenger Entity to personally deliver all or a subset of said Private Entity's Private Information 103. Said Private Entity stores said Private Information 103 with authorization and Release Policy Information 104 allowing the transfer of said Private Information 103 to a third Private Entity upon presentation of the device by the second messenger Entity. In another example, said second messenger Entity and said third Entity may be the same Entity. These examples are but a few of the scenarios supported for authorized and protected transfer of Private Information 103 from a Proactive Repository 101 to another Entity by the use of a portable device.

In some embodiments, all or a subset of first Private Information 103 may be flagged by a first Private Entity and made available with Temporary Authorization to a second Private Entity. The Temporary Authorization may be stored within said first Private Information 103 in the Proactive Repository 101 and/or may be stored on a portable device. For example, suppose a family associated with said first Private Entity goes on vacation, and the second Private Entity is a professional Pet Sitter or a friend of the family. During this time, said first Private Entity authorizes said second Private Entity with feeding instructions and veterinary care permissions for the family pet. The Temporary Authorization permits the Pet Sitter to act on behalf of the Private Entity for the emergency veterinary care of the pet.

In another example, the landlord of at least one rental creates a Temporary Authorization for each tenant that has signed a lease agreement. Each authentication has an expiration time and date corresponding to conditions set forth in the lease. Each authorized tenant is then enabled to enter and edit any Private Information 103 pertaining to their dwelling and/or their tangibles. The ability of the Proactive Repository 101 to temporarily assign and authorize permissions is embodied in the functions of the Proactive Repository 101 as will be understood by one of ordinary skill in the relevant art in light of this specification.

In some embodiments, an organization such as a public or private business or enterprise maintains their own Proactive Repository 101. Said Proactive Repository 101 retains information about those Entities associated with said public or private business or enterprise. Upon an activation by a Dispatcher 108, said public or private business or enterprise provides Private Information to Emergency Responders, who are responding to said activation.

In some embodiments, all or a subset of a first Private Entity's first Private Information 103 residing on a first Proactive Repository 101 is made available via Limited or Temporary Authorization established by said first Private Entity, such that the First Entity's Private Information 103 is made available as part of a second Entity's Private Information 103 in a second Proactive Repository 101. In such a case, accessing the Private Information 103 of said second Private Entity includes access to said first Private Information 103 as allowed by said Limited or Temporary Authorization(s). Said first Private Entity and said Second Private Entity may represent the same Entity, or they may be different. Said first Proactive Repository 101 and said second Proactive Repository 101 may represent the same Proactive Repository 101, or they may be different. Said Limited or Temporary Authorization may be specified by said first Private Entity or by another Entity responsible for the administration, backup, and/or reliability of said first Proactive Repository 101. Said first Proactive Repository 101 and said second Proactive Repository 101 may be connected via a Global Telecommunications Network.

In one example, a Private Entity maintains Private Information 103 in one Proactive Repository 101, but wishes to make accessible all or a subset of said information in a second Proactive Repository 101. For example, a family keeping photos of children in a Proactive Repository 101 maintained by their insurance carrier could also want to make the same information available to Emergency Responders via a second Proactive Repository 101 maintained by their municipality.

In another example, a small community or retirement facility has chosen to maintain a Proactive Repository 101 for their residents, but at the same time, wishes to make available most of the same Private Information 103 via the Proactive Repository 101 accessed by the Dispatcher 108 for their geographic region. The implementation mechanics of representing all or a subset of information from one Proactive Repository 101 such that it is accessible in some form in the same or another Proactive Repository 101 will be apparent to one of ordinary skill in the relevant art in light of this specification, and may be expanded to include multiple or simultaneous types or modes of representations and implementations.

In some embodiments, a Proactive Repository 101 can be configured to interface with a first Electronic Agent via a Global Telecommunications Network, such that said first Electronic Agent can be authorized to transmit information to the Proactive Repository 101 to accept electronic documents (e.g., electronic office documents, electronic mail, etc.). The Release Policy Information 104 can be configured for one of a variety of configurations. For example, one configuration can accept the electronic document, perform a cryptographic signing process on the document, and store the document within the Proactive Repository 101 appropriately for the Entity that said first Electronic Agent represents. In another configuration, an electronic document can be authenticated and accepted by the Proactive Repository 101, any and all identifying information about the origin, creator, and sender of the electronic document can be stripped from the document, the document can be cryptographically signed by the Proactive Repository 101, and then the document can be transmitted to at least one recipient second Entity or their Electronic Agent. Thus the Proactive Repository 101 can certify the authentication of said first Electronic Agent and the content of said electronic document, without revealing creator, origin, or sender information to any Entity. An example of a use of this configuration would be for an electronic news service to accept information for public dissemination from qualified writers who do not want to be known publicly. The Proactive Repository 101 in such an example belongs to such news service and authenticates it sources, thereby authenticating the content of the information published.

A Proactive Repository 101, in itself, is an implementation of information. Therefore, information from a first Proactive Repository 101 can be stored within a second Proactive Repository 101. The Release Policy Information 104 of said second Proactive Repository 101 would uniquely govern the release of said first Proactive Repository 101 information, or the Release Policy Information 104 could be composed of a pre-determined merge of Release Policy Information 104 from said first Proactive Repository 101 with that of the Release Policy Information 104 from said second Proactive Repository 101. In one embodiment, said first Proactive Repository 101 can contain last will and testament information from a Primary Entity, and said second Proactive Repository 101 can be that of the Primary Entity's probate lawyer, whereby said first Proactive Repository 101 is released from said second Proactive Repository 101 upon the death of Primary Entity (the Release Event).

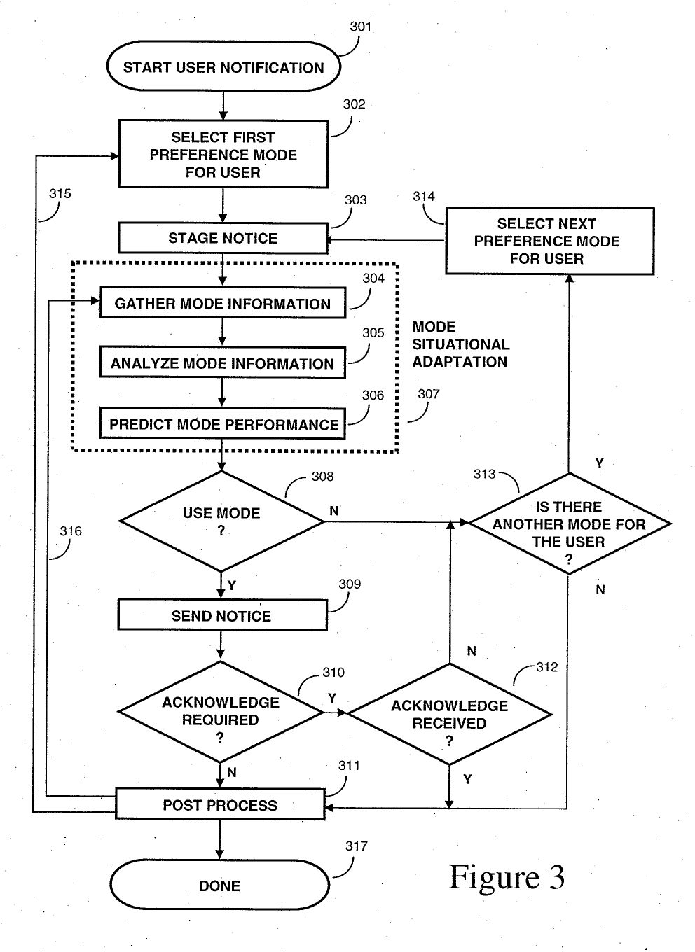

The Proactive Repository 101 can utilize a multi-modal notification process as part of Notification Delivery 112. FIG. 3 illustrates the notification process for a recipient of information who has previously indicated at least one notification method, according to some embodiments of the present invention. When the Proactive Repository 101 is ready to release a notification to a recipient, it starts the Notification Delivery 112 process as implemented starting with Start User Notification 301. For the recipient, their first notification preference information is retrieved from the Proactive Repository 101 and examined in Select First Preference Mode For Recipient 302. Dependent on the selected mode, a prepared via Stage Notice 303. For example, if the first preference is for telephone with voice delivery, the notification is converted to voice and prepared to be sent to an indicated phone number. One of ordinary skill in the relevant art will note that other forms of notification are possible, such as an electronic mail message to be sent to a recipient via the Internet, or the preparation of a Short Message Service (SMS) notification to be sent via the mobile phone system.

The Stage Notice 303 process prepares a notification in proper form for the mode indicated in the recipient's preferences. Before Send Notice 309, the Proactive Repository 101 examines at least one of a number of conditions related to the availability of the selected mode to ensure that mode is available for the recipient in Use Mode? 308. For example, observing if the mode is operating at a sufficiently high availability to ensure timely delivery. The processes of mode evaluation include Gather Mode Information 304, Analyze Mode Information 305, and Predict Mode Performance 306. These three steps are all part of Mode Situational Adaptation 307. These process steps ensure that no one mode of notification will prevent a notification from reaching the recipient within an acceptable period of time. For example, the local telephone switch serving the community may be saturated and unable to place calls. Information is collected via Gather Mode Information 304 for Analyze Mode Information 305. Predict Mode Performance 306 takes into account current and past performance of the mode. This process may also dictate parameters for scheduling methods that control the pace of notices delivered to the mode. If it is known that the intended mode of operation is near its saturation point, notifications can be scheduled so as not to saturate the mode. The Proactive Repository 101 can schedule at the specified notification per second rate (pace), which is also termed the acceptance rate of the mode. In one embodiment the Proactive Repository 101 determines the rate without specific feedback from the provider of the mode. In another embodiment, the Proactive Repository 101 schedules the rate based upon direct feedback from the mode provider. In another example, the mode of operation may have an emergency priority that reserves a portion of its total capacity for the emergency traffic, where the acceptance rate must not be exceeded. Overall, if the mode is available, the notice is sent in Send Notice 309. If the mode is not available, then a check is made to see if the recipient has a next preferred mode for notification in Is There Another Mode For The User? 313. If so, the next preference mode is selected in Select Next Preference Mode For Recipient 314, and then Stage Notice 303. If there is no next available preference in Is There Another Mode For User? 313, Post Process 311 performs tasks based on the status of the notification. For example if a notice could not be sent, it may be re-queued for that modality or another modality so that it can be retried until successful or the notification is superseded or cancelled. The notification process can simply be restarted for the user 315, or transferred back 316 to Gather Mode Information to re-evaluate Mode Situational Adaptation 307. After Post Process 311, the notification process for that recipient is Done 317.

Some notifications or modes of notification can provide an acknowledgement of receipt. If so required in Acknowledge Required 310, the notification process waits for an acknowledgement from the recipient in Acknowledge Received 312. If received, Post Process 311 performs any additional processing and then the notification process is Done 317 for that recipient. Otherwise, a check is made to see if there are any remaining preference modes available In There Another Mode For The User? 313, as described above. A mode of notification may have none, one, or more mechanism(s) to indicate successful receipt. For example, a telephone-based notification may allow a speech recognition or utterance system to allow the recipient to confirm by voice. A Dual-Tone Multi-Frequency system (DMTF) can allow the telephone dialing pad to be used. Electronic mail can use a reply back to sender method to indicate acknowledgement. One of ordinary skill in the relevant art will note that any given mode of notification may have none, one, or more method(s) by which acknowledgements can be used with a Proactive Repository 101 to indicate receipt. One of ordinary skill in the relevant art will note that there are underlying mechanisms that may be used to support the assured delivery of notices via one or more modes. These may include mechanisms such as but not limited to one or more queuing and scheduling disciplines to assure best performance of the mode. For example, the Proactive Repository 101 can schedule (pace) notifications delivered to a mode so as to meet an input rate criteria that maintains delivery time performance requirements yet does not saturate the mode. Rate adjustments may be performed in real-time, based on an observation period, or may be provisioned for the mode, etc. In addition, one of ordinary skill in the relevant art will note that FIG. 3 represents a summary of a single user notice processing. The Proactive Repository 101 can include both serial and parallel processing to delivery notices to more than one Entity. It is to be understood that Post Process 311 is general in nature, and can include other operations as desired.

As noted above, FIG. 3 illustrates the steps of a notification process for a single recipient. A flowchart illustrating the process for a multi-modal process for all recipients of a notification would be unnecessarily complicated and would obscure the essence of the description. Likewise, timers, counters, mechanisms for deferring or re-queuing notifications, etc. have been omitted from the figure so as to not obscure the essentials of the description.

The determination of availability of a mode in Mode Situational Adaptation 307 can contain or make use of at least one measurement or observation processes to assess the ability of the mode to ensure successful delivery of a notification. One measurement, for example, may be based a pre-determined knowledge of the call switching capacity of the local telephone company's central office. The Proactive Repository 101 can decide to limit its own loading of said switch to a percentage fraction of that switching capacity. Said fraction could be different for different types of notifications. This is just one example of a measurement. Other measurements and/or observation methods may be used to determine mode availability as desired. An Entity may be an organization, a company, a service provider, etc. As such, said Entity may, at their option, send the notification to their employees, their customers, their subscribers, etc.

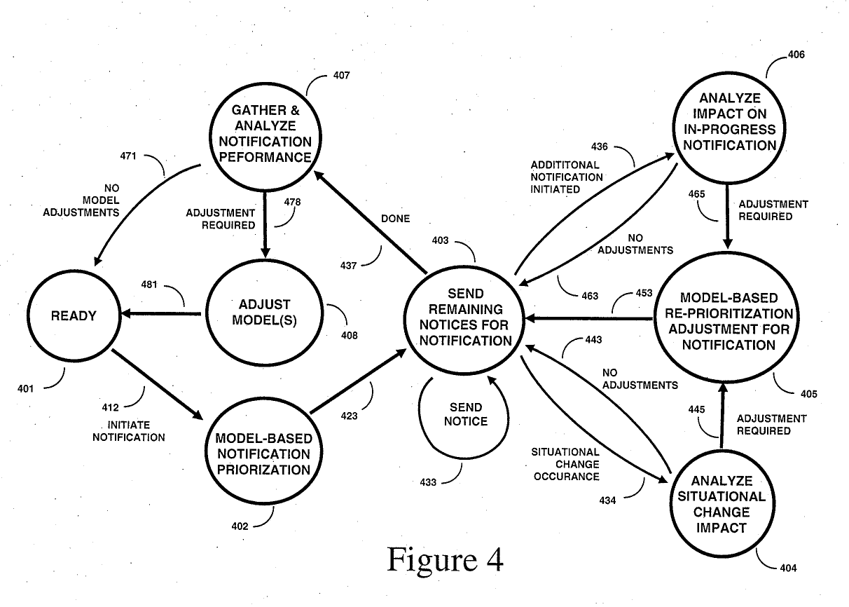

FIG. 4 represents the notification process used in one embodiment of the invention for the processing of a notification by the Proactive Repository 101. The Ready 401 state is the idle state for the notification sending process. When a notification is initiated 412 a Model-Based Notification Prioritization 402 is made that establishes the order in which notices are dispatched via 423 the Send Remaining Notices for Notification State 403. The Send Notice 433 loop is implemented in one embodiment of the invention by the process as illustrated in FIG. 3. While Send Remaining Notices for Notification 403 is in process, two types of events may occur that can alter the current process. A situational change may occur 434, responsive to which the Analysis Situational Change Impact 404 state determines if a Model-Based Re-Prioritization Adjustment for Notification 405 needs to be performed 445. Otherwise, no adjustments are made 443. The other event type is that when in Send Remaining Notices of Notification 403 at least one additional notification can be initiated 436. In this case, the Analyze Impact on In-Progress Notification 406 evaluates if a Model-based Re-Prioritization Adjustment for Notification 405 adjustment 465 is needed. Otherwise, no adjustment is made 463.

After there are no notifications remaining (e.g., either exhausted, cancelled, or otherwise) i.e., Done 437, the system performs Gather and Analyze Notification Performance 407. The system may decide to alter the models used for prioritizations in Model-Based Notification Prioritization 402 and Model-Based Re-Prioritization Adjustment for Notification 405. This is accomplished via 478 and Adjust Model(s) 408. This establishes the ability for the Proactive Repository's 101 Notification Delivery 112 process to learn. If there is no need to adjust models, then the system transitions 471 back to Ready 401. One of ordinary skill in the relevant art will note that FIG. 4 represents a massively parallel process according to one embodiment of the invention, which creates notifications, dispatches notifications, alters notification priorities, etc. One of ordinary skill in the relevant art will also note that FIG. 4 illustrates an embodiment of the invention where the state path is clearly for one notification only. Other embodiments of the invention may overlap or share states for implementation reasons. The Model-Based Re-Prioritization Adjustment for Notification 405 can cancel Notifications as well as schedule Notifications for Entities that were not included in the original set. This permits the process to adapt to a wide range of situational changes. Additionally, the Analyze Impact on In-Progress Notification 406 can place new notifications at a higher, same, or lower priority in the overall notification dispatch process. The prioritization and re-prioritization process spans not only the single notification in progress but across the parallel processes of delivering all notifications in the system.

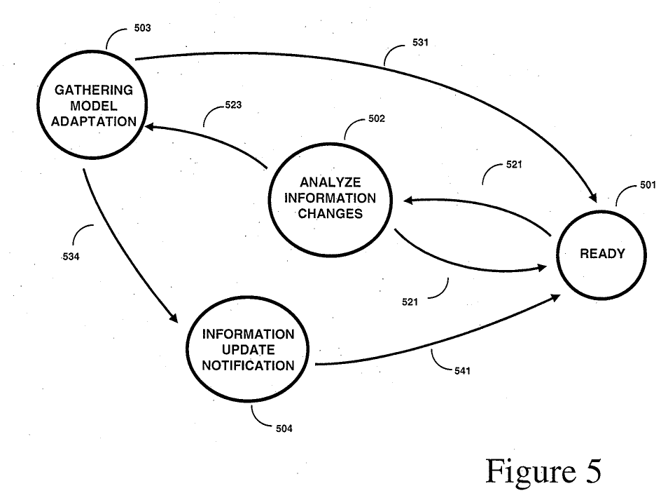

The Proactive Repository 101 can be configured with at least one Information Maintenance 211 method. FIG. 5 is an illustration of such an embodiment in which a method is implemented to adjust the information gathering templates and methodologies, based on changes in the information available to the Proactive Repository. The method consists of a Ready 501 state, which is an idle state. Whenever notifications are made or the environment changes, the method transitions 521 to Analyze Information Changes 502. In this state, the method examines all information available to the Proactive Repository 101. The examination may determine that no changes need to be made and the system returns 521 to Ready 501. In this embodiment of the invention, the method seeks information changes that may require changes 523 to the information gathering templates, web pages, etc. that are used to gather Public Information Input/Edit 204, Private Information Input/Edit 205, and Release Policy Input/Edit 206. Gathering Model Adaptation 503 makes any required changes. The entire maintenance process can be performed, in which case the system returns 531 to Ready 501. Some modification may require at least one or more Entities to be notified of information gathering updates 534 that are performed by Information Update Notification 504, at which time the system returns 541 to Ready 501. Gathering Model Adaptation 503 may not require any notification 531 and the system returns to Ready 501. The Adaptive Learning method illustrated in FIG. 5 may alter information and alert settings for existing and/or new citizens and subscribers. For example, said citizens and subscribers may be members of a set (i.e., Entities) that have similar profiles. This method permits the Proactive Repository 101 to proactively gather information and alter the gathering of information in response to changing events in the community it serves. One of ordinary skill in the relevant art will note that other methods may be implemented to alter other aspects of the Proactive Repository's 101 behavior. For example, the analysis of a major geographic event, such as a large-scale 50-year or 100-year flood, may result in altering previous expected threat probabilities that were put in place for disaster planning. A geographic footprint change would necessarily impact emergency preparedness of those affected homes and businesses. An adaptive method could alter preparedness questions as well as home and property survey questions for citizens and subscribers. In addition, a notification could be sent to those existing citizens and subscribers that are impacted by the change. New citizens and subscribers to the system would be presented with the already updated survey questions. One of ordinary skill in the relevant art will note that other learning methods may be used that alter and improve the information delivered by the Proactive Repository 101 to at least one recipient Entity. The use of many different forms of learning and behavior changes are possible.

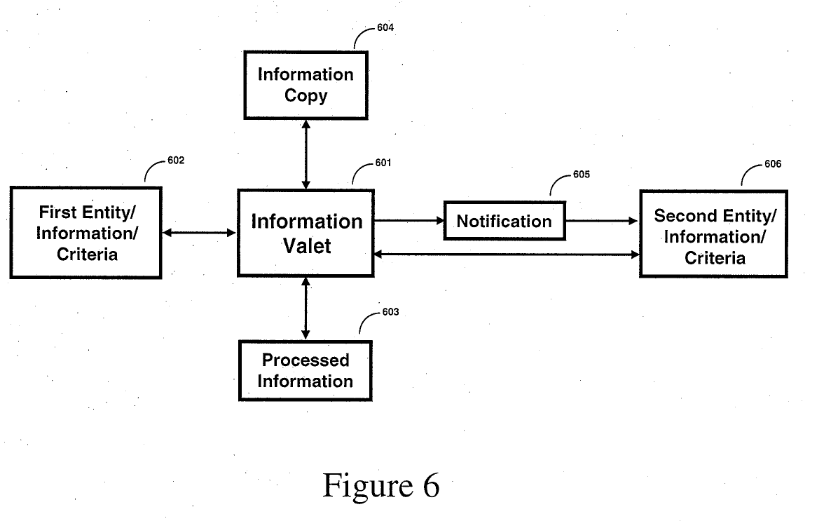

FIG. 6 illustrates an additional role of the Proactive Repository 101, in which it is configured as an Information Valet 601, according to some embodiments of the present invention. In the mode of operation illustrated in FIG. 6, the Information Valet 601 accepts information from the First Entity/Information/Criteria 602 to store a duplicate of the original as Information Copy 604. Said information may be manipulated and stored as Processed Information 603, either directly or indirectly by the Information Valet 601. Upon conditions specified in the First Entity/Information/Criteria 602, the Processed Information 603 is made available to at least one Second Entity/Information/Criteria 606, either by Notification 605 or via other access made directly with the Information Valet 601. Said first First Entity/Information/Criteria 602 may retrieve said Information Copy 604 or Processed Information 603 at any time. For example, a blind person receives an electronic text document from another Entity. Said blind person stores said document in their Information Valet 601 with the directions to process and convert said document into speech, storing said document and said speech for later retrieval. Later, said blind person accesses their Information Valet 601 to hear the processed speech. At a later time, said blind person, may access their Information Valet 601 and direct that said processed speech be sent to a Second Entity/Information/Criteria 606.

In another embodiment of the Information Valet 601, a First Entity 602 stores electronic information in the Information Valet 601 of a Second Entity/Information/Criteria 606 based upon authorization criteria established by said Second Entity/Information/Criteria 606. Said information is accepted, stored, processed and made available for release according to the Criteria established by said Second Entity/Information/Criteria 606. One of skill in the relevant art will note that the Information from the First Entity/Information/Criteria 602 may be merged with the Information of the Second Entity/Information/Criteria 606.

In another embodiment, the system is configured to perform the role of an authenticated anonymous drop box. That is, Information from a First Entity 602 with associated identification credentials is presented to the Information Valet 601. The Information Valet 601 authenticates the identity for the First Entity/Information/Criteria 602 and conditionally accepts the Information for processing. Said processing removes all identification credentials, optionally encrypts all or a portion of the remaining Information, and stores same as Processed Information 603. An Information Copy 604 is not retained. A Second Entity/Information/Criteria 606 is informed of the arrival of new Processed Information 603. The Processed Information 603 is then made available either directly or via a Notification 605. The Second Entity/Information/Criteria 606 is assured that the Processed Information 603 originated from a bona fide First Entity/Information/Criteria 602, even through the identity of the First Entity/Information/Criteria 602 has been removed from the Processed Information 603. Functions of the Information Valet 601 may be supplied or outsourced to a third-party. Furthermore, the Information Valet 601 may be able to communicate with at least one other Information Valet 601 and/or Proactive Repository 101 over a Global Telecommunications Network.

These examples of the Proactive Repository 101 performing as an Information Valet 601 are but a few of the scenarios supported by this mode of operation. One of ordinary skill in the relevant art will note that the criteria for operation of the Information Valet 601 may be specified by either the First Entity/Information/Criteria 602, the Second Entity/Information/Criteria 606, or by both Entities. In addition, the Information Copy 604 or Processed Information 603 may be stored temporarily, permanently, or not at all.

While the foregoing descriptions have described the use of the Proactive Repository 101 for providing business, household, individual, and family information to public service Emergency Responders, it will be apparent to one of ordinary skill in the relevant art in light of this specification that the Proactive Repository 101 can also be used by National, State, and Local agencies for providing information to a state or federal responder (e.g. agent, marshal, federal officer, homeland security officer, or other suitably authorized Entity, etc.) in response to any event that requires proactive knowledge prior to arriving at the event or processing information from an event. One of ordinary skill in the relevant art will also note that the scope of a Proactive Repository 101 need not parallel governmental boundaries and may be used by Entities whose membership spans business or other organizational boundaries.

As will be understood by one of ordinary skill in the relevant art, the invention may be embodied in other specific forms without departing from the spirit or essential characteristics thereof. Likewise, the particular naming and division of the modules, agents, managers, functions, procedures, actions, layers, features, attributes, methodologies and other aspects are not mandatory or significant, and the mechanisms that implement the embodiments of the invention or its features may have different names, divisions and/or formats. Furthermore, as will be apparent to one of ordinary skill in the relevant art, the modules, agents, managers, functions, procedures, actions, layers, features, attributes, methodologies and other aspects of the embodiments of the invention can be implemented as software, hardware, firmware or any combination of the three. Of course, wherever a component of an embodiment of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of ordinary skill in the relevant art of computer programming. Additionally, embodiments of the present invention are in no way limited to implementation in any specific programming language, or for any specific operating system or environment. Accordingly, the disclosure of embodiments of the present invention is intended to be illustrative, but not limiting, of the scope of the invention. In some instances, well-known technology and services are referenced by definition in order to avoid obscuring the present invention. Of course, where embodiments of the invention are implemented at least partially as a physical system, components of the invention can be implemented as computers, databases, memory sticks, personal digital assistants, or other computing devices. These various computing devices can but need not utilize at least one central processing unit, can but need not be combined with radio frequency identifiers and can be centralized or distributed, as desired. Public Information 102, Private Information 103, and Release Policy Information 104 do not need to be stored in a single physical place in order to be associated with a single Proactive Repository 101.

What is claimed is:

1. A method of information collection and release of said information to at least one recipient, the method comprising the steps of:
gathering first information from at least one input Entity;
associating Release Policy Information gathered from at least one Entity concerning the release of said first information;
storing said first information and said Release Policy Information;
waiting for a Release Event that was specified in said Release Policy Information; and
releasing at least a portion of said first information to at least one recipient Entity as specified in said Release Policy Information.

2. The method of claim 1 where said first information further comprises Private Information gathered from an Entity.

3. The method of claim 1 where the Release Event is initiated by a Dispatcher.

4. The method of claim 1 where at least one recipient Entity is an Emergency Responder.

5. The method of claim 1 where the Release Event is initiated by a Sensor.

6. The method of claim 1 where at least a portion of said first information is conveyed via a notification to at least one recipient Entity.

7. The method of claim 1 where the gathering of information from at least one source further comprises the authentication of said input sources and the gathering of information is subject to an authorization obtained once authenticated.

8. A system for information collection and dissemination, the system comprising:
at least one source of input information;
at least one source of Release Policy Information input;
storage for said input information and said Release Policy Information input;
a detection portion configured to evaluate Release Event input; and
a conveyance portion configured to disseminate said input information to at least one recipient Entity based on the stored Release Policy Information input.

9. The system of claim 8 where said conveyance portion further comprises an electronic mail system configured to communicate at least a portion of said input information to at least one recipient via a Global Telecommunications Network.

10. The system of claim 8 where said conveyance portion process further comprises a telephone network configured to communicate a voice message containing at least a portion of said input information via a telephone call to at least one recipient.

11. The system of claim 8 where said conveyance portion further comprises a mobile telephone network configured to communicate an electronic text message containing at least a portion of said input information to at least one recipient.

12. The system of claim 11 where said text message further comprises a Short Message Service (SMS) message.

13. A method of multi-modal notification, the method comprising the steps of:
selecting a first preference mode for a recipient Entity;
preparing a first notification based upon said first preference mode;
evaluating whether said first preference mode is available for use; and
taking at least one additional step in response to results of said evaluating step.

14. The method of claim 13, further comprising:
conveying said first notification to the recipient Entity responsive to said first preference mode being available.

15. The method of claim 14, further comprising:
receiving an acknowledgement for said first notification.

16. The method of claim 14, further comprising, responsive to said first preference mode not being available for use and to a next preference mode being available for said recipient, performing the steps of:
selecting a next preference mode for said recipient Entity;
preparing a next notification based upon said next preference mode;
evaluating whether said next preference mode is available for use; and
conveying said next notification to said recipient Entity responsive to said next preference mode being available.

17. The method of claim 13 wherein evaluating whether said next preference mode is available for use further comprises performing the steps of:
gathering information about the performance of a mode;
analyzing information about the performance of a mode; and
predicting mode performance and availability for use.

18. The method of claim 16 wherein evaluating whether said next preference mode is available for use further comprises performing the steps of:
gathering information about the performance of a mode;
analyzing information about the performance of a mode; and
predicting mode performance and availability for use.

19. The method of claim 14, wherein conveying is further comprised of the step of:
scheduling said first notification to the recipient Entity in response to the acceptance rate criteria associated with the first preference mode.

20. The method of claim 16, wherein conveying is further comprised of the step of:
scheduling said next notification to the recipient Entity in response to the acceptance rate criteria associated with the next preference mode.
